(19) United States
(12) Patent Application Publication
(10) Pub. No.: US 2025/0278662 A1
(43) Pub. Date: Sep. 4, 2025

(54) SIGNAL DETERMINATION METHOD BASED ON QUANTUM GENETIC ALGORITHM, QUANTUM COMPUTING DEVICE AND MEDIUM

(71) Applicant: YANGTZE DELTA INDUSTRIAL INNOVATION CENTER OF QUANTUM SCIENCE AND TECHNOLOGY, Suzhou (CN)

(72) Inventors: Yu ZHANG, Suzhou (CN); Bo FAN, Suzhou (CN); Yanguo JIA, Suzhou (CN); Yun WANG, Suzhou (CN)

(21) Appl. No.: 19/210,292

(22) Filed: May 16, 2025

Related U.S. Application Data
(63) Continuation of application No. PCT/CN2024/115419, filed on Aug. 29, 2024.

(30) Foreign Application Priority Data
Oct. 27, 2023 (CN) 202311405849.2

(51) Int. Cl. G06N 10/60; G06N 10/20

(52) U.S. Cl. CPC G06N 10/60; G06N 10/20

(57) ABSTRACT

The application discloses a signal determination method based on a quantum genetic algorithm, including: constructing qubits based on the number and length of phase-coded radar signals transmitted by a radar system and the number of chromosomes; determining a gene sequence of the first chromosome based on all the qubits; judging whether there exists a first chromosome that satisfies a preset termination condition; if yes, taking the first chromosome that satisfies a preset termination condition as a phase-coded radar signal transmitted by the radar system; if no, updating all the first chromosomes based on the mutation probability, a preset crossover strategy, a quantum catastrophe strategy and the rotation angle to obtain second chromosomes; and replacing all the first chromosomes in each of the populations with all the second chromosomes, proceeding to the judgment step, and ending the operation until a termination condition is met.

### CROSS-REFERENCE TO RELATED APPLICATIONS

The present application is a continuation of International Application No. PCT/CN2024/115419, with an international filing date of Aug. 29, 2024, which is based upon and claims priority to Chinese Patent Application No. 202311405849.2, filed on Oct. 27, 2023, the entire contents of all of which are incorporated herein by reference.

### TECHNICAL FIELD

The disclosure relates to a field of radar signal waveform design, particularly to a signal determination method based on a quantum genetic algorithm, a quantum computing device and a medium.

### BACKGROUND

With the development of military technology, the requirements for radar technology have become higher and higher. Nowadays, phase coding signals are commonly used as waveforms of radar transmission, i.e., the phase-coded radar signals are determined by a signal determination system, and the radar system is connected to the signal determination system to transmit the corresponding phase-coded radar signals outwards and receive the corresponding echo signals so as to realize the detection function of radar. The most common phase-coded radar signal is a binary-phase-coded radar signal, which, as a signal with low power and large time-width bandwidth product, has complex coding laws, higher performance and stronger anti-interference ability. Accordingly, as the code length of the binary-phase-coded radar signal increases, the process of searching and determining the binary-phase-coded radar signal becomes more complicated, and the search for the binary-phase-coded radar signal only by virtue of the conventional exhaustive enumeration method is time-consuming and inefficient.

In related techniques, a genetic algorithm is generally used to determine phase-coded radar signals. In determining phase-coded radar signals using a genetic algorithm, it is necessary to generate an appropriate number of population individuals based on the radar system pairs, i.e., to determine the population size, and then to calculate the fitness of each individual in the population, calculate the probability of an individual to be selected into the next iteration based on the fitness, select the individuals to enter the next generation through roulette, and generate the next generation through crossover and mutation after selection, i.e., reflecting the process of population evolution through crossover and mutation. The crossover is to exchange a part of chromosome segments among individuals based on a preset crossover strategy, reconstitute the individuals and enter the next generation. The mutation is to change the segments within the individual based on a certain mutation probability, and to regenerate the individual and enter the next generation. An optimal fitness value is recalculated after each iteration until the current fitness value meets the requirements or the maximum number of iterations has been reached. Then, the optimization is stopped and a final result is outputted as a phase-coded radar signal. However, this method is limited by the number of individuals in the population, i.e., limited by the population size. When the population size is small, the search space is reduced and a local optimum appears, which affects the reliability of the results of the genetic algorithm, and can not obtain the phase-coded radar signals with optimal performance. When the population size is larger, the number of computation increase proportionally, the convergence speed is too slow, and the search efficiency decreases accordingly.

### SUMMARY

The disclosure aims at providing a signal determination method based on a quantum genetic algorithm, which improves the search speed, saves resources, has higher convergence speed under the condition of the same population size, and improves the search efficiency of phase-coded radar signals.

In order to solve the above technical problem, the disclosure provides a signal determination method based on a quantum genetic algorithm, applied to a signal determination system, wherein the signal determination system is connected to a radar system, the determination method comprising:
determining the number of phase-coded radar signals transmitted by the radar system and a length of phase-coded radar signals transmitted by the radar system;
constructing P*G*C qubits based on the determined algorithm operation parameters, the algorithm operation parameters comprising population number P, chromosome number C, gene number G, rotation angle θ, mutation probability and termination parameters, the population number P is the number of phase-coded radar signals transmitted by the radar system, the gene number G is the length of phase-coded radar signals transmitted by the radar system, and P, C, G and θ are all greater than 0;
determining gene sequences of P*C first chromosomes based on all the qubits, each population comprising C first chromosomes, and each of the first chromosomes comprising G qubits;
judging whether there exists a first chromosome that satisfies a preset termination condition in all the first chromosomes; wherein, the termination condition is set based on the termination parameters;
if yes, taking the first chromosome that satisfies a preset termination condition as a phase-coded radar signal transmitted by the radar system;
if no, updating all the first chromosomes based on the mutation probability, a preset crossover strategy, a quantum catastrophe strategy and the rotation angle θ to obtain P*C second chromosomes, each of the populations comprising C second chromosomes, and each of the second chromosomes comprising G qubits; and
replacing all the first chromosomes in each of the populations with all the second chromosomes, and proceeding to the step of judging whether there exists a first chromosome that satisfies a preset termination condition in all the first chromosomes.

In one aspect, when the phase-coded radar signal is a binary-phase-coded radar signal, the step of constructing P*G*C qubits based on the determined algorithm operation parameters comprises:
constructing P*G*C qubits in a uniform superposition state based on the determined algorithm operation parameters;
the step of determining gene sequences of P*C first chromosomes based on all the qubits comprising:
determining a corresponding classical bit state after all the qubits are collapsed, the value of the classical bit state is 0 or 1; and
determining P*C first chromosomes based on all the classical bit states, the first chromosome is a binary sequence comprising G classical bit states.

In one aspect, after determining C first chromosomes based on all the classical bit states, the method further comprises:
restoring all collapsed qubits to a pre-collapse state based on all the classical bit states.

In one aspect, the step of updating all the first chromosomes based on the mutation probability, a preset crossover strategy, a quantum catastrophe strategy and the rotation angle θ to obtain P*C second chromosomes comprises:
determining m unmutated chromosomes in all the first chromosomes based on the mutation probability, m is a positive integer not greater than C;
applying a preset X gate to all the unmutated chromosomes to obtain m third chromosomes, the X gate is:

$$X = [ \begin{matrix}0 & 1 \\ 1 & 0\end{matrix} ] ;$$

updating C-m first chromosomes and m third chromosomes based on a preset crossover strategy, a quantum catastrophe strategy and the rotation angle θ to obtain P*C second chromosomes.

In one aspect, the crossover strategy is a full interference crossover strategy.

In one aspect, the step of updating C-m first chromosomes and m third chromosomes based on a preset crossover strategy, a quantum catastrophe strategy and the rotation angle θ to obtain P*C second chromosomes comprises:
combining C-m first chromosomes and m third chromosomes as new first chromosomes; and
determining fitness values of all the new first chromosomes based on all the new first chromosomes and a preset fitness relational expression;
updating all the new first chromosomes based on the rotation angle θ, a target chromosome with the largest fitness value in the last iteration, and a preset quantum rotating gate expression to obtain P*C fourth chromosomes, the quantum rotating gate expression is:

$$U ( {θ}_{i} ) = [ \begin{matrix}cos ( {θ}_{i} ) & - sin ( {θ}_{i} ) \\ sin ( {θ}_{i} ) & cos ( {θ}_{i} )\end{matrix} ] ;$$

wherein, θᵢ=0 when the i^{th} classical bit state of any chromosome in the new first chromosomes is the same as the i^{th} classical bit state of the target chromosome with the largest fitness value in the last iteration; determining a rotation direction based on the quadrant where any chromosome in the new first chromosomes is located, and adjusting θᵢ based on the rotation direction and a set adjustment angle when the i^{th} classical bit state of any chromosome in the new first chromosomes is different from the i^{th} classical bit state of the target chromosome with the largest fitness value in the last iteration;
determining a target chromosome with the largest fitness value in the next iteration based on the chromosome with the largest fitness value in all the fourth chromosomes and the target chromosome with the largest fitness value in the last iteration;
judging whether the number of consecutive set times of the target chromosome with the largest fitness value is unchanged; wherein the number of set times is determined based on the total iteration times and a set proportion;
initializing the rest chromosomes in all the fourth chromosomes except the chromosome with the largest fitness value based on a set replacement proportion, so as to obtain a second chromosome when the number of consecutive set times of the target chromosome with the largest fitness value is unchanged; and
taking the fourth chromosome as the second chromosome when the number of consecutive set times of the target chromosome with the largest fitness value is changed.

In one aspect, when the termination parameters comprise a fitness threshold, the step of determining whether there exists a first chromosome that satisfies a preset termination condition in all the first chromosomes comprises:
determining fitness values of all the first chromosomes based on all the first chromosomes and a preset fitness relational expression;
judging whether there exists a first chromosome with the fitness value being not less than the fitness threshold in all the first chromosomes;
if yes, judging that there exists a first chromosome that satisfies a preset termination condition in all the first chromosomes; and
if no, judging that there does not exist a first chromosome that satisfies a preset termination condition in all the first chromosomes.

The disclosure further provides a quantum computing device based on a quantum genetic algorithm, applied to a signal determination system for phase-coded radar signals, wherein the signal determination system is connected to a radar system, the quantum computing device comprising:
a quantum building module for constructing P*G*C qubits based on the determined algorithm operation parameters, the algorithm operation parameters comprising population number P, chromosome number C, gene number G, rotation angle θ, mutation probability and termination parameters, the population number P is the number of phase-coded radar signals transmitted by the radar system, the gene number G is the length of the phase-coded radar signals transmitted by the radar system, and P, C, G and θ are all greater than 0;
a first chromosome determination module for determining gene sequences of P*C first chromosomes based on all the qubits, each population comprising C first chromosomes, and each of the first chromosomes comprising G qubits;
a termination condition judging module for judging whether there exists a first chromosome that satisfies a preset termination condition in all the first chromosomes; wherein, the termination condition is set based on the termination parameters;
a termination module, if yes, for taking the first chromosome that satisfies a preset termination condition as a phase-coded radar signal transmitted by the radar system;
a second chromosome determination module, if no, for updating all the first chromosomes based on the mutation probability, a preset crossover strategy, a quantum catastrophe strategy and the rotation angle θ to obtain P*C second chromosomes, each of the populations comprising C second chromosomes, and each of the second chromosomes comprising G qubits; and
a loop module for replacing all the first chromosomes in each of the populations with all the second chromosomes, and proceeding to the step of judging whether there exists a first chromosome that satisfies a preset termination condition in all the first chromosomes.

The disclosure further provides a signal determination system based on a quantum genetic algorithm, comprising:
a quantum computing device for executing the steps of a signal determination method based on a quantum genetic algorithm based on any one of the above embodiments; and
a radar system for transmitting phase-coded radar signals determined based on the quantum computing device and receiving an echo corresponding to the phase-coded radar signals.

The disclosure further provides a computer-readable storage medium, wherein the computer-readable storage medium has a computer program stored thereon, the computer program is executed by a signal determination system to execute the steps of the signal determination method based on a quantum genetic algorithm based on any one of the above embodiments.

The disclosure provides a signal determination method based on a quantum genetic algorithm, a quantum computing device and a medium. The signal determination method comprises: determining the number of phase-coded radar signals transmitted by the radar system and a length of phase-coded radar signals transmitted by the radar system; constructing P*G*C qubits based on the determined algorithm operation parameters, the algorithm operation parameters comprising population number P, chromosome number C, gene number G, rotation angle θ, mutation probability and termination parameters, the population number P is the number of phase-coded radar signals transmitted by the radar system, the gene number G is the length of phase-coded radar signals transmitted by the radar system, and P, C, G and θ are all greater than 0; determining gene sequences of P*C first chromosomes based on all the qubits, each population comprising C first chromosomes, and each of the first chromosomes comprising G qubits; judging whether there exists a first chromosome that satisfies a preset termination condition in all the first chromosomes; wherein, the termination condition is set based on the termination parameters; if yes, taking the first chromosome that satisfies a preset termination condition as the phase-coded radar signals transmitted by the radar system; if no, updating all the first chromosomes based on the mutation probability, a preset crossover strategy, a quantum catastrophe strategy and the rotation angle θ to obtain P*C second chromosomes, each of the populations comprising C second chromosomes, and each of the second chromosomes comprising G qubits; and replacing all the first chromosomes in each of the populations with all the second chromosomes, and proceeding to the step of judging whether there exists a first chromosome that satisfies a preset termination condition in all the first chromosomes. In the technical solution, qubits are constructed using the number of populations, chromosomes and genes, so as to enrich the diversity of chromosomes. Quantum rotating gates constructed with rotation angles are used as executors of the population evolution. The parallel computing features can expand the search space and improve the convergence speed. The chromosomes mutation is realized based on the mutation probability, preset crossover strategy, quantum catastrophe strategy and the rotation angle, which jumps out of the local optimum, and improves the search quality. Therefore, under the condition of the same population size, the convergence speed is faster, and the search efficiency of the phase-coded radar signal is improved.

### BRIEF DESCRIPTION OF THE DRAWINGS

In order to more clearly explain the technical solution in the embodiments of the disclosure, drawings required in the prior art and the embodiments can be briefly described below. Obviously, the drawings in the following description are some embodiments of the disclosure. For those skilled in the art, other drawings can be obtained from these drawings without any creative effort.

FIG. 1 is a flowchart of a signal determination method based on a quantum genetic algorithm provided by an embodiment of the disclosure;

FIG. 2 is a table of algorithm operation parameters provided by an embodiment of the disclosure;

FIG. 3 is a diagram of a classical-quantum hybrid computing system provided by an embodiment of the disclosure;

FIG. 4 is a table of test data setting for algorithm operation parameters provided by an embodiment of the disclosure;

FIG. 5 is a result diagram of obtaining a binary-phase-coded radar signal based on a quantum genetic algorithm provided by an embodiment of the disclosure;

FIG. 6 is another result diagram of obtaining a binary-phase-coded radar signal based on a quantum genetic algorithm provided by an embodiment of the disclosure;

FIG. 7 is a structural schematic diagram of a quantum computing device based on a quantum genetic algorithm provided by an embodiment of the disclosure;

FIG. 8 is a structural schematic diagram of a signal determination system based on a quantum genetic algorithm provided by an embodiment of the disclosure.

### DETAILED DESCRIPTION OF THE EMBODIMENTS

The disclosure provides a signal determination method based on a quantum genetic algorithm, which improves the search speed, saves resources, has higher convergence speed under the condition of the same population size, and improves the search efficiency of phase-coded radar signals.

To make the purpose, technical solution, and advantages of the embodiments of the disclosure clearer, the technical solutions of the embodiments of the disclosure can be described clearly and completely as follows with reference to the drawings in the embodiments of the disclosure. Obviously, the described embodiments are part of, but not all of, the embodiments of the disclosure. Based on the embodiments of the disclosure, all the other embodiments obtained by those skilled in the art without paying any creative work fall within the protection scope of the disclosure.

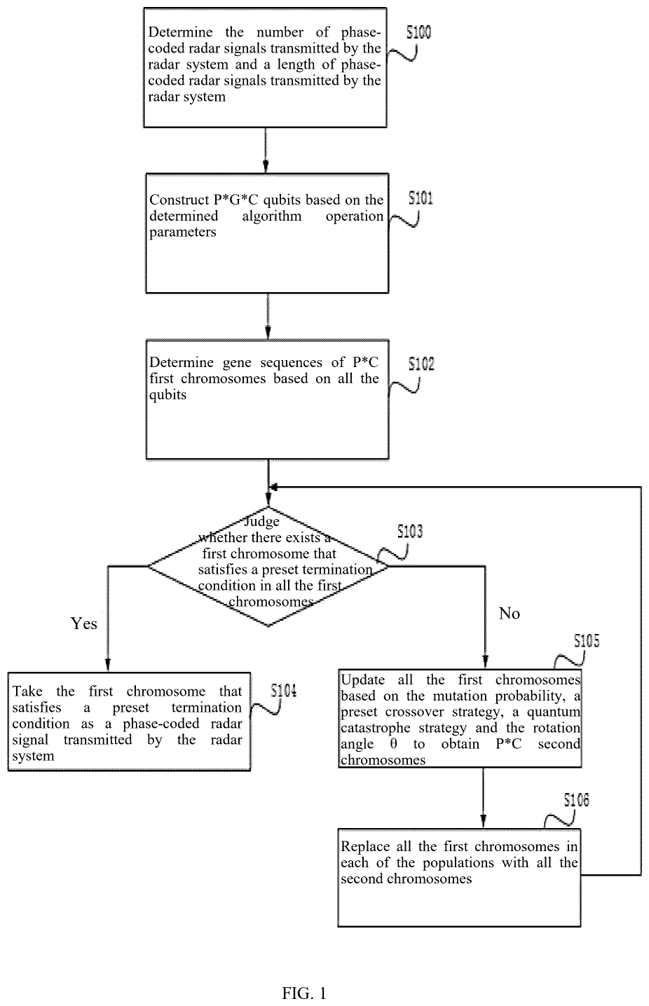

Referring to FIG. 1, FIG. 1 is a flowchart of a signal determination method based on a quantum genetic algorithm provided by an embodiment of the disclosure, applied to a signal determination system, wherein the signal determination system is connected to a radar system, the determination method including:
S100: determining the number of phase-coded radar signals transmitted by the radar system and a length of phase-coded radar signals transmitted by the radar system.
S101: constructing P*G*C qubits based on the determined algorithm operation parameters, the algorithm operation parameters including population number P, chromosome number C, gene number G, rotation angle θ, mutation probability and termination parameters, the population number P is the number of phase-coded radar signals transmitted by the radar system, the gene number G is the length of phase-coded radar signals transmitted by the radar system, and P, C, G and θ are all greater than 0.

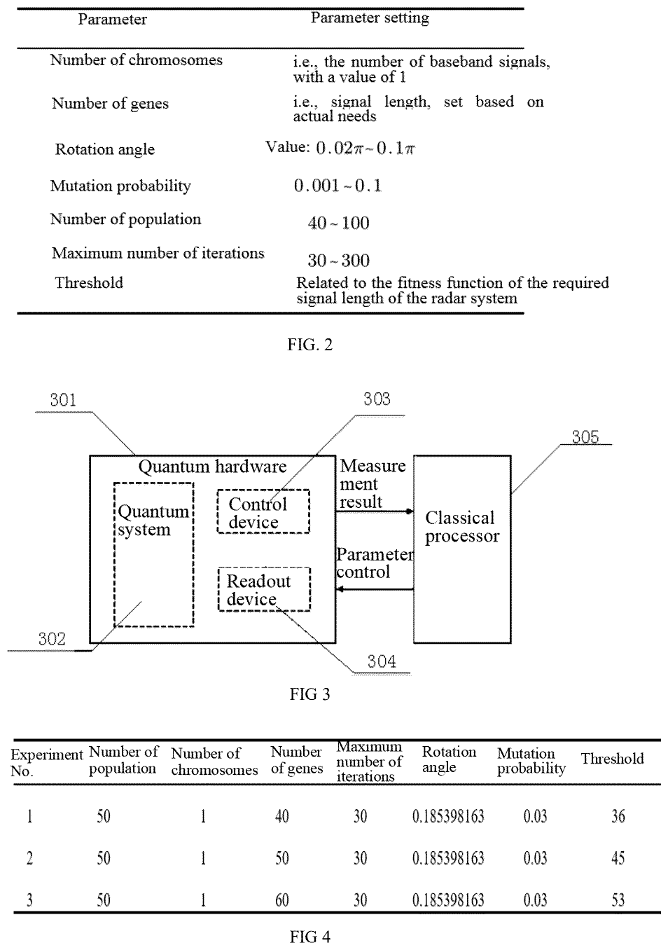

In some embodiments, before using a quantum genetic algorithm to determine phase-coded radar signals, it can determine algorithm operation parameters that affect the precision, reliability and efficiency of the quantum genetic algorithm, and the quality of the search result and the system performance. That is, population number P, chromosome number C, gene number G, rotation angle θ, mutation probability and termination parameters are set by analyzing the characteristics of phase-coded radar signals with good properties. A larger rotation angle can expand the search space of the quantum genetic algorithm, but it can miss the optimal solution and cause prematurity. A smaller rotation angle can slow down the speed of generating new individuals, and thus the rotation angle should not be smaller. A larger mutation probability can cause the algorithm to be a pure random algorithm, while a smaller value can cause the search to fall into a local solution. The number of population and maximum number of iterations have less impact. Parameters are designed comprehensively based on the above analysis and reference to relevant literature. Referring to FIG. 2, FIG. 2 is a table of algorithm operation parameters provided by an embodiment of the disclosure.
S102: determining gene sequences of P*C first chromosomes based on all the qubits, wherein each population includes C first chromosomes, and each of the first chromosomes includes G qubits.
S103: judging whether there exists a first chromosome that satisfies a preset termination condition in all the first chromosomes.
S104: if yes, taking the first chromosome that satisfies a preset termination condition as a phase-coded radar signal transmitted by the radar system.
S105: if no, updating all the first chromosomes based on the mutation probability, a preset crossover strategy, a quantum catastrophe strategy and the rotation angle θ to obtain P*C second chromosomes, wherein each of the populations includes C second chromosomes, and each of the second chromosomes includes G qubits.
S106: replacing all the first chromosomes in each of the populations with all the second chromosomes, and proceeding to the step of judging whether there exists a first chromosome that satisfies a preset termination condition in all the first chromosomes.

In some embodiments, in order to find optimal phase-coded radar signals, after determining the gene sequences of all the first chromosomes, it is judged whether there exists a first chromosome that satisfies a preset termination condition in all the first chromosomes. The termination condition can be set based on the termination parameters. The termination parameters can include a fitness threshold or a preset iteration threshold.

It should be noted that the present embodiment does not limit the specific content of the termination condition. Taking the termination parameters including a fitness threshold as an example, for example, the fitness of all the first chromosomes can be calculated through a fitness relational expression. If there is a first chromosome with the fitness greater than the preset fitness threshold, it is determined that there exists a first chromosome that satisfies the termination condition.

Taking the termination parameters including a preset iteration threshold as an example, the number of iteration corresponding to the first chromosome can be judged. If the number of iteration reaches the preset iteration threshold, it is determined that there exists a first chromosome that satisfies the termination condition. Or there can be other termination conditions, which should be selected by those skilled in the art based on the actual situations.

If there is no first chromosome that satisfies the termination condition, the individuals in the other population perform genetic iteration of the first chromosome based on the mutation probability, the preset crossover strategy, the quantum catastrophe strategy and the rotation angle θ to obtain P*C second chromosomes. After the information of the first chromosome and the second chromosome is recorded, all the first chromosomes in each population are replaced with all the second chromosomes, and the judgement as to whether or not there is a first chromosome that satisfies the preset termination condition in all the first chromosomes is re-performed until there exists a first chromosome that satisfies the preset termination condition, and the loop is ended.

The disclosure provides a signal determination method based on a quantum genetic algorithm, a quantum computing device and a medium. The determination method includes: determining the number of phase-coded radar signals transmitted by the radar system and a length of phase-coded radar signals transmitted by the radar system; constructing P*G*C qubits based on the determined algorithm operation parameters, the algorithm operation parameters including population number P, chromosome number C, gene number G, rotation angle θ, mutation probability and termination parameters, the population number P is the number of phase-coded radar signals transmitted by the radar system, the gene number G is the length of phase-coded radar signals transmitted by the radar system, and P, C, G and θ are all greater than 0; determining gene sequences of P*C first chromosomes based on all the qubits, each population including C first chromosomes, and each of the first chromosomes including G qubits; judging whether there exists a first chromosome that satisfies a preset termination condition in all the first chromosomes; wherein, the termination condition is set based on the termination parameters; if yes, taking the first chromosome that satisfies a preset termination condition as a phase-coded radar signal transmitted by the radar system; if no, updating all the first chromosomes based on the mutation probability, a preset crossover strategy, a quantum catastrophe strategy and the rotation angle θ to obtain P*C second chromosomes, each of the populations including C second chromosomes, and each of the second chromosomes including G qubits; and replacing all the first chromosomes in each of the populations with all the second chromosomes, and proceeding to the step of judging whether there exists a first chromosome that satisfies a preset termination condition in all the first chromosomes. In the technical solution, qubits are constructed using the number of populations, chromosomes and genes, so as to enrich the diversity of chromosomes. Quantum rotating gates constructed with rotation angles are used as executors of the population evolution. The features of the parallel computing can expand the search space and improve the convergence speed. The mutation of the chromosomes is realized based on the mutation probability, preset crossover strategy, quantum catastrophe strategy and the rotation angle, which jumps out of the local optimum, and improves the search quality. Therefore, under the condition of the same population size, the convergence speed is faster, and the search efficiency of the phase-coded radar signals is improved.

### On the Basis of the Above Embodiments:

In some embodiments, when the phase-coded radar signal is a binary-phase-coded radar signal, the step of constructing P*G*C qubits based on the determined algorithm operation parameters includes:

constructing P*G*C qubits in a uniform superposition state based on the determined algorithm operation parameters;

In some embodiments, after the algorithm operation parameters are determined, P*G*C qubits are constructed on a hardware level, and an H gates operate on each qubit, so that each qubit is in a uniform superposition state, which can be expressed as:

$$\vert φ 〉 = {\underbrace{\vert ++ ⋯ ++ 〉}}_{P \times G \times C} = \frac{1}{\sqrt{P \times G \times C}} ( \vert 00 ⋯00 〉 + \vert 00 ⋯01 〉 + ⋯ + \vert 11 ⋯11 〉 ) \vert + 〉 = \frac{1}{\sqrt{2}} ( \vert 0 〉 + \vert 1 〉 ) = \frac{1}{\sqrt{2}} ( [ \begin{matrix}1 \\ 0\end{matrix} ] + [ \begin{matrix}0 \\ 1\end{matrix} ] ) = \frac{1}{\sqrt{2}} [ \begin{matrix}1 \\ 1\end{matrix} ] ;$$

wherein, any qubit |ϕ [symbol] is represented as |ϕ [symbol] =α|0 [symbol] +β|1 [symbol] , and the two constants α and β satisfy α²+β²=1; in the measurement, a qubit in the uniform superposition state collapses to the state|0 [symbol] with the probability of α² and to the state |1 [symbol] with the probability of β².

The step of determining gene sequences of P*C first chromosomes based on all the qubits includes:
determining a corresponding classical bit state after all the qubits are collapsed, the value of the classical bit state is 0 or 1; and
determining P*C first chromosomes based on all the classical bit states, the first chromosome is a binary sequence including G classical bit states.

In some embodiments, each individual is defined to have one chromosome, each chromosome includes G qubits, and each qubit is measured to collapse to a classical bit state of 0 or 1, respectively, with a probability of one-half to obtain a set of determined individual states P₀={p₁⁰, p₂⁰, . . . . . . , p_{C}⁰}, wherein pⱼ⁰ is the state of the j^{th} individual in the population, expressed as a binary sequence (x₁, x₂, . . . , x_{G}) with a length G, and the value of xᵢ is 0 or 1.

Referring to FIG. 3, FIG. 3 is a diagram of a classical-quantum hybrid computing system provided by an embodiment of the disclosure. The classical quantum hybrid computing system consists of a quantum hardware 301 and a classical processor 305, wherein the quantum hardware includes a quantum system 302, a control device 303 and a readout device 304. The relationship between the devices is as follows: a quantum system 302, which includes a quantum chip and a quantum memory and is used for storing and processing quantum information and realizing generation, operation and measurement of quantum states. A control device 303 is used for controlling the operation of the quantum system including regulating the voltage for generating the quantum state, adjusting the time sequence, and adjusting the transition between the quantum states, etc. A readout device 304 is used for measuring and recording information of a quantum system, including measuring a quantum state, converting the quantum state into a classical electric signal, sending the classical electric signal to a classical processor for processing, etc. A classical processor 305 is used for coordinating with a quantum system, including controllers and signal processing, etc., for executing programming, optimization and simulation of improved quantum genetic algorithm and other quantum algorithms.

The information exchanged between the quantum hardware 301 and the classical processor 305 includes:
1) quantum state information: the quantum state in a chip is read out by a readout device and is processed in parallel;
2) control signal: the classical processor regulates and controls a quantum system through the control signal;
3) readout data: the readout data is converted into a classic electric signal by a readout device and the classic electric signal is sent to a classical processor for processing;
4) metadata: used for configuring the running environment of the quantum computing and monitoring the state of the quantum computing process;
5) physical parameter information: the classical processor obtains the corresponding physical parameter information to perform optimization feedback for more efficient controlling and computing.

In some embodiments, a binary sequence with a length G is formed by a corresponding classical bit state after the qubits in a uniform superposition state are collapsed, thereby determining the gene sequence of the chromosome to obtain discrete signal codes. Compared with a particle swarm algorithm and a quantum particle swarm algorithm in the prior art, the method can be applied to solve the discrete problem without the need of more quantum gates and auxiliary qubits while overcoming the local optimum, has lower requirements for hardware and saves hardware resources.

In some embodiments, after determining C first chromosomes based on all the classical bit states, the method further includes:
restoring all collapsed qubits to a pre-collapse state based on all the classical bit states.

In some embodiments, after the quantum is measured, i.e., after the qubit is collapsed to a classical bit state, a set of identical quantum gate operations are performed at each time step in order to prevent the qubit from reducing phase information after the measurement, and thus to maintain its superposition state before the measurement. Continuous measurement is carried out, and the measurement result of the qubit is recorded at the end of each time step. Based on the measurement result, feedback control and correction of the state of the qubit are performed, i.e., the state of the qubit is reconstructed by processing the measurement result and used for subsequent calculation and storage. The above operations are repeatedly conducted until the desired accuracy is achieved.

In some embodiments, the step of updating all the first chromosomes based on the mutation probability, a preset crossover strategy, a quantum catastrophe strategy and the rotation angle θ to obtain P*C second chromosomes includes:
determining m unmutated chromosomes in all the first chromosomes based on the mutation probability, m is a positive integer not greater than C;
applying a preset X gate to all the unmutated chromosomes to obtain m third chromosomes, the X gate is:

$$X = [ \begin{matrix}0 & 1 \\ 1 & 0\end{matrix} ] ;$$

updating C-m first chromosomes and m third chromosomes based on a preset crossover strategy, a quantum catastrophe strategy and the rotation angle θ to obtain P*C second chromosomes. In practical applications, the value of P can be 1.

In some embodiments, the qubit of each individual in the population is mutated through X gate, i.e., the probability of the qubit collapsed to 0 or 1 is reversed through the X gate. It fully demonstrates the advantages of quantum computing and provides a theoretical basis for the construction of quantum computers.

In some embodiments, the crossover strategy is a full interference crossover strategy.

In some embodiments, all the individuals in the population are randomly sorted through a full interference crossover strategy, and the i^{th} bit of all the individuals after sorting is cyclically displaced i−1 times to obtain a new population after the crossover operation. In this way, information among each quantum chromosome is fully used, thus reducing the probability of occurrence of a local optimum.

In some embodiments, the step of updating C-m first chromosomes and m third chromosomes based on a preset crossover strategy, a quantum catastrophe strategy and the rotation angle θ to obtain P*C second chromosomes includes:
combining C-m first chromosomes and m third chromosomes as new first chromosomes; and
determining fitness values of all the new first chromosomes based on all the new first chromosomes and a preset fitness relational expression;
updating all the new first chromosomes based on the rotation angle θ, a target chromosome with the largest fitness value in the last iteration, and a preset quantum rotating gate expression to obtain P*C fourth chromosomes, the quantum rotating gate expression is:

$$U ( {θ}_{i} ) = [ \begin{matrix}cos ( {θ}_{i} ) & - sin ( {θ}_{i} ) \\ sin ( {θ}_{i} ) & cos ( {θ}_{i} )\end{matrix} ] ;$$

wherein, θᵢ=0 when the i^{th} classical bit state of any chromosome in the new first chromosomes is the same as the i^{th} classical bit state of the target chromosome with the largest fitness value in the last iteration; determining a rotation direction based on the quadrant where any chromosome in the new first chromosomes is located, and adjusting θᵢ based on the rotation direction and a set adjustment angle when the i^{th} classical bit state of any chromosome in the new first chromosomes is different from the i^{th} classical bit state of the target chromosome with the largest fitness value in the last iteration.

For example, assuming that the i^{th} classical bit state of the target chromosome with the largest fitness value in the last iteration is 0, if the i^{th} classical bit state of any chromosome in the new first chromosomes is 0, i.e., both of which are the same, θᵢ of any chromosome in the new first chromosome is 0.

A probability amplitude can be expressed based on cos (θ) and sin (θ). When the value of cos (θ) is larger than that of sin (θ), the classical bit state is 0; and when the value of cos (θ) is smaller than that of sin (θ), the classical bit state is 1. In practical application, an x-axis can be taken as the classical bit state 0 and a y-axis can be taken as the classical bit state 1, and the rotation direction of any chromosome can be determined by combining the quadrant in which any chromosome is located. The direction of rotation can include clockwise rotation or counterclockwise rotation.

For example, assuming that the i^{th} classical bit state of the target chromosome with the largest fitness value in the last iteration is 0, if the i^{th} classical bit state of any chromosome in the new first chromosomes is 1, i.e., both of which are different, the quadrant in which any chromosome is located can be determined based on the rotation angle of the chromosome, and the rotation direction can be determined. Assuming that any one of the chromosomes is in the first quadrant, the rotation direction should be clockwise in order to make the chromosome approach the target chromosome with the largest fitness value. Assuming that any one of the chromosomes is in the second quadrant, the rotation direction should be counterclockwise in order to make the chromosome approach the target chromosome with the largest fitness value. The adjustment angle can be selected from the value range of the rotation angle in FIG. 2.
determining a target chromosome with the largest fitness value in the next iteration based on the chromosome with the largest fitness value in all the fourth chromosomes and the target chromosome with the largest fitness value in the last iteration;

If the fitness value of the chromosome with the largest fitness value in all the fourth chromosomes is larger than the fitness value of the target chromosome with the largest fitness value in the last iteration, the chromosome with the largest fitness value in all the fourth chromosomes is taken as the target chromosome with the largest fitness value in the next iteration.

If the fitness value of the chromosome with the largest fitness value in all the fourth chromosomes is smaller than or equal to the fitness value of the target chromosome with the largest fitness value in the last iteration, the target chromosome with the largest fitness value in the last iteration is taken as the target chromosome with the largest fitness value in the next iteration.
judging whether the number of consecutive set times of the target chromosome with the largest fitness value is unchanged; wherein the number of set times is determined based on the total iteration times and a set proportion;
initializing the rest chromosomes in all the fourth chromosomes except the chromosome with the largest fitness value based on a set replacement proportion, so as to obtain a second chromosome when the number of consecutive set times of the target chromosome with the largest fitness value is unchanged;
taking the fourth chromosome as the second chromosome when the number of consecutive set times of the target chromosome with the largest fitness value is changed.

In some embodiments, based on an update strategy of a quantum rotating gate, the optimal individual of the previous generation is selected as the evolution target, i.e., the first chromosome with the highest fitness value is selected, and the fitness relational expression is:

$$F ( X ) = G - max ( {\sum }_{i = 0}^{G - 1 - τ} {x}_{i} + {x}_{i + τ} ) , τ = 1 , 2 , ⋯⋯ , G - 1 ;$$

wherein, X is the X^{th} first chromosome, xᵢ is the i^{th} classical bit state in the X^{th} first chromosome, and x_{i+τ} is the i+τ^{th} classical bit state in the X^{th} first chromosome; when the fitness relational expression is introduced, the classical bit state 0 is replaced by −1, 1 remains unchanged, and the fitness function value is obtained.

The quantum rotating gate is constructed based on the set rotation angle θ, so that individuals in the population rotate towards the target individuals, and the updating process is as follows:

$$[ \begin{matrix}{α}_{i}^{′} \\ {β}_{i}^{′}\end{matrix} ] = U ( θ ) [ \begin{matrix}{α}_{i} \\ {β}_{i}\end{matrix} ] = [ \begin{matrix}cos ( {θ}_{i} ) & - sin ( {θ}_{i} ) \\ sin ( {θ}_{i} ) & cos ( {θ}_{i} )\end{matrix} ] [ \begin{matrix}{α}_{i} \\ {β}_{i}\end{matrix} ] ;$$

### The Final Result Obtained is:

$$\{ \begin{matrix}{α}_{i}^{′} & = {α}_{i} cos ( {θ}_{i} ) - {β}_{i} cos ( {θ}_{i} ) \\ {β}_{i}^{′} & = {α}_{i} sin ( {θ}_{i} ) + {β}_{i} cos ( {θ}_{i} )\end{matrix} ;$$

wherein, (αᵢ, βᵢ)^{T} and (α′ᵢ, β′ᵢ)^{T} represent the probability amplitude of the it qubit of an individual before and after being updated by the rotating gate.

In some embodiments, the individual with the largest fitness value can be regarded as the optimal individual. After determining the optimal individual in the population of the current generation, it can compare the fitness of the optimal individual with that of the optimal individual of the previous generation. If the fitness of the optimal individual of the current generation is greater than that of the optimal individual of the previous generation, the fitness of the optimal individual in the population of the current generation is taken as the target value of the quantum rotating gate of the next generation. If the fitness of the optimal individual of the previous generation is smaller than that of the optimal individual of the previous generation, the fitness of the optimal individual of the previous generation is taken as the target value of the quantum rotating gate of the next generation.

On this basis, if the fitness of the optimal individual remains unchanged, i.e., no individual with higher fitness is produced, after a certain number of consecutive generations during the evolutionary process, the algorithm is determined to obtain a local optimum. At this time, a quantum catastrophe can avoid the local optimum. Specifically, the current optimal individual and a part of random individuals in the current population are saved, and other individuals which are not saved are replaced by initial individuals, to re-form a new population to continue to participate in evolution. In general, the number of consecutive generations that have passed through a certain number of generations is one-tenth of the maximum number of evolutionary generations, and a part of random individuals in the current population are two-fifths of the random individuals in the current population.

For example, the total number of iterations is 100, the set proportion is 1/10, and the substitution ratio is 3/5. When the target chromosome with the largest fitness value has not changed for 100*1/10=10 times continuously, the chromosome with the largest fitness value in all the current chromosomes and ⅖ of the chromosomes randomly selected from the remaining chromosomes can be saved, all the unsaved chromosomes are initialized. Therefore, the saved chromosomes and the initialized chromosome are combined as the second chromosomes. In the embodiment, the quantum rotating gate enables the corresponding qubit to collapsed to an optimal individual state with a greater probability after measurement, thereby accelerating the convergence speed and improving the efficiency.

In some embodiments, when the termination parameters include a fitness threshold, the step of determining whether there exists a first chromosome that satisfies a preset termination condition in all the first chromosomes includes:
determining fitness values of all the first chromosomes based on all the first chromosomes and a preset fitness relational expression;
judging whether there exists a first chromosome with the fitness value being not less than the fitness threshold in all the first chromosomes;
if yes, judging that there exists a first chromosome that satisfies a preset termination condition in all the first chromosomes; and
if no, judging that there does not exist a first chromosome that satisfies a preset termination condition in all the first chromosomes.

In some embodiments, when the termination parameters include a preset iteration threshold, the step of determining whether there exists a first chromosome that satisfies a preset termination condition in all the first chromosomes includes:
judging whether the current number of iterations of all the first chromosomes reaches a preset iteration threshold;
if yes, judging that there exists a first chromosome that satisfies a preset termination condition in all the first chromosomes; and
if no, judging that there does not exist a first chromosome that satisfies a preset termination condition in all the first chromosomes.

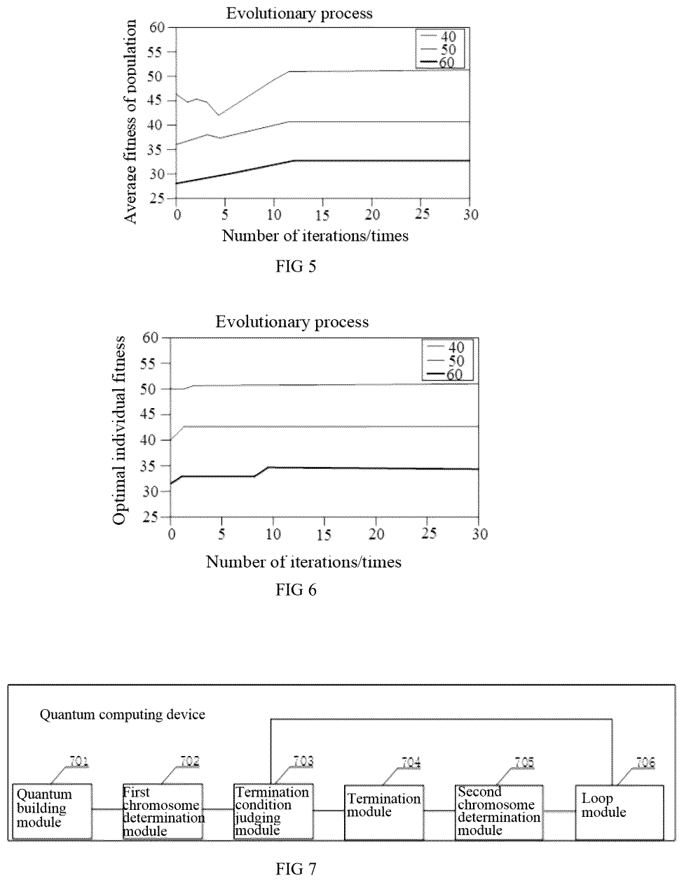

In some embodiments, whether the fitness of the first chromosome reaches the fitness threshold or whether the number of iterations reaches the iteration threshold is taken as a preset termination condition, to ensure that the population gradually converges to the optimal solution as the iterations proceed. Referring to FIG. 4, FIG. 5 and FIG. 6 for details. FIG. 4 is a table of test data setting for algorithm operation parameters provided by an embodiment of the disclosure; FIG. 5 is a result diagram of obtaining a binary-phase-coded radar signal based on a quantum genetic algorithm provided by an embodiment of the disclosure; and FIG. 6 is another result diagram of obtaining a binary-phase-coded radar signal based on a quantum genetic algorithm provided by an embodiment of the disclosure.

After comprehensive design of important operating parameters based on repeated experiments and with reference to relevant literatures, signal lengths are selected from three sets of data, 40, 50 and 60, respectively, for experimentation. According to FIG. 5, it can be analyzed by comparing the results of the experiments that under the condition of ensuring the selection of appropriate parameters, the average fitness of the population as a whole continues to increase with the number of evolutions as the number of genes increases, i.e., the length of the binary-phase-coded radar signal increases. When the signal length is 50 or 60, the number of evolutionary generations is about 5, an average fitness decreases. However, with the evolution of the population, the average fitness increases again, indicating that the full interference crossover, mutation operator and catastrophe strategy is an important role in the evolution of the population. FIG. 6 shows the relationship between the optimal individual fitness and the evolutionary generation. Comparing the experimental results, it can be seen that the optimal individual fitness is optimized in different degrees, and the overall fitness is relatively high. It indicates that the acquired binary-phase-coded radar signal has a low sidelobe peak value of non-periodic autocorrelation function. Similarly, the optimization effect can still be improved by adjusting the mutation probability, rotation angle, etc. in the follow-up.

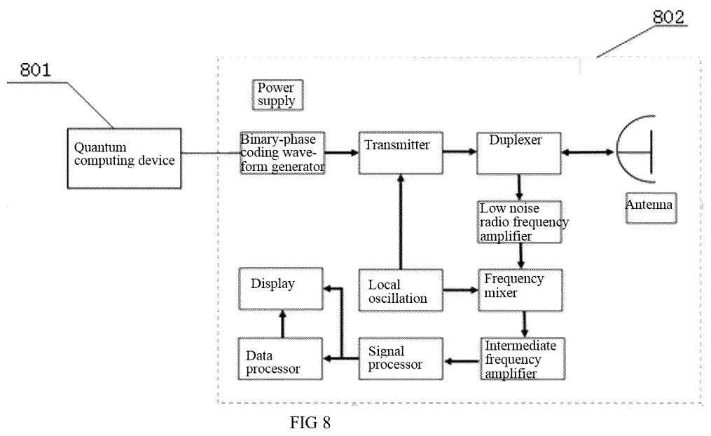

Referring to FIG. 7, FIG. 7 is a structural schematic diagram of a quantum computing device based on a quantum genetic algorithm provided by an embodiment of the disclosure. The quantum computing device based on a quantum genetic algorithm is applied to a signal determination system for phase-coded radar signals, wherein the signal determination system is connected to a radar system, the quantum computing device including:
a quantum building module 701 for constructing P*G*C qubits based on the determined algorithm operation parameters, the algorithm operation parameters including population number P, chromosome number C, gene number G, rotation angle θ, mutation probability and termination parameters, the population number P is the number of phase-coded radar signals transmitted by the radar system, the gene number G is the length of the phase-coded radar signals transmitted by the radar system, and P, C, G and θ are all greater than 0;
a first chromosome determination module 702 for determining gene sequences of P*C first chromosomes based on all the qubits, each population includes C first chromosomes, and each of the first chromosomes includes G qubits;
a termination condition judging module 703 for judging whether there exists a first chromosome that satisfies a preset termination condition in all the first chromosomes; wherein, the termination condition is set based on the termination parameters;
a termination module 704, if yes, for taking the first chromosome that satisfies a preset termination condition as a phase-coded radar signal transmitted by the radar system;
a second chromosome determination module 705, if no, for updating all the first chromosomes based on the mutation probability, a preset crossover strategy, a quantum catastrophe strategy and the rotation angle θ to obtain P*C second chromosomes, each of the populations includes C second chromosomes, and each of the second chromosomes includes G qubits; and
a loop module 706 for replacing all the first chromosomes in each of the populations with all the second chromosomes, and proceeding to the step of judging whether there exists a first chromosome that satisfies a preset termination condition in all the first chromosomes.

In some embodiments, when the phase-coded radar signal is a binary-phase-coded radar signal, a quantum building module includes:
a uniform superposition state building module for constructing P*G*C qubits in a uniform superposition state based on the determined algorithm operation parameters;
a first chromosome determination module, including:
a classical bit state building module for determining a corresponding classical bit state after all the qubits are collapsed, the value of the classical bit state is 0 or 1;
determining P*C first chromosomes based on all the classical bit states, the first chromosome is a binary sequence including G classical bit states.

In some embodiments, a quantum building module includes:
a qubit recovery module for restoring all collapsed qubits to a pre-collapse state based on all the classical bit states.

In some embodiments, a second chromosome determination module includes:
an unmutated chromosome determination module for determining m chromosomes in all the first chromosomes based on the mutation probability, m is a positive integer not greater than C;
an X-gate module for applying a preset X gate to all the unmutated chromosomes to obtain m third chromosomes, the X gate is:

$$X = [ \begin{matrix}0 & 1 \\ 1 & 0\end{matrix} ] ;$$

a first mutation module for updating C-m first chromosomes and m third chromosomes based on a preset crossover strategy, a quantum catastrophe strategy and the rotation angle θ to obtain P*C second chromosomes.

In some embodiments, the crossover strategy is a full interference crossover strategy.

In some embodiments, a first mutation module is used for combining C-m first chromosomes and m third chromosomes as new first chromosomes; and
determining fitness values of all the new first chromosomes based on all the new first chromosomes and a preset fitness relational expression;
updating all the new first chromosomes based on the rotation angle θ, a target chromosome with the largest fitness value in the last iteration, and a preset quantum rotating gate expression to obtain P*C fourth chromosomes, the quantum rotating gate expression is:

$$U ( {θ}_{i} ) = [ \begin{matrix}cos ( {θ}_{i} ) & - sin ( {θ}_{i} ) \\ sin ( {θ}_{i} ) & cos ( {θ}_{i} )\end{matrix} ] ;$$

wherein, θᵢ=0 when the i^{th} classical bit state of any chromosome in the new first chromosomes is the same as the i^{th} classical bit state of the target chromosome with the largest fitness value in the last iteration; determining a rotation direction based on the quadrant where any chromosome in the new first chromosomes is located, and adjusting θᵢ based on the rotation direction and a set adjustment angle when the i^{th} classical bit state of any chromosome in the new first chromosomes is different from the i^{th} classical bit state of the target chromosome with the largest fitness value in the last iteration;
determining a target chromosome with the largest fitness value in the next iteration based on the chromosome with the largest fitness value in all the fourth chromosomes and the target chromosome with the largest fitness value in the last iteration;
judging whether the number of consecutive set times of the target chromosome with the largest fitness value is unchanged; wherein the number of set times is determined based on the total iteration times and a set proportion;
initializing the rest chromosomes in all the fourth chromosomes except the chromosome with the largest fitness value based on a set replacement proportion, so as to obtain a second chromosome when the number of consecutive set times of the target chromosome with the largest fitness value is unchanged; and
taking the fourth chromosome as the second chromosome when the number of consecutive set times of the target chromosome with the largest fitness value is changed.

In some embodiments, when the termination parameters include a fitness threshold, a termination condition judging module is used for:
a second fitness determination module for determining fitness values of all the first chromosomes based on all the first chromosomes and a preset fitness relational expression;
a fitness judgement module for judging whether there exists a first chromosome with the fitness value being not less than the fitness threshold in all the first chromosomes;
a condition satisfying module, if yes, for judging that there exists a first chromosome that satisfies a preset termination condition in all the first chromosomes; and
a condition unsatisfying module, if no, for judging that there does not exist a first chromosome that satisfies a preset termination condition in all the first chromosomes.

In some embodiments, when the termination parameters include a preset iteration threshold, a termination condition judging module is used for:
judging whether the current number of iterations of all the first chromosomes reaches a preset iteration threshold;
if yes, judging that there exists a first chromosome that satisfies a preset termination condition in all the first chromosomes; and
if no, judging that there does not exist a first chromosome that satisfies a preset termination condition in all the first chromosomes.

Referring to FIG. 8, FIG. 8 is a structural schematic diagram of a signal determination system based on a quantum genetic algorithm provided by an embodiment of the disclosure, including:
a quantum computing device 801 for executing the steps of a signal determination method based on a quantum genetic algorithm based on any one of the above embodiments; and
a radar system 802 for transmitting phase-coded radar signals determined based on the quantum computing device 801 and receiving an echo corresponding to the phase-coded radar signals.

When the phase-coded radar signals having good non-periodic characteristics output from the quantum computing device 801 is used as an input of a waveform generator in the radar system 802, a corresponding baseband signal is generated by the waveform generator. The radar system 802 includes an antenna, a waveform generator, a transmitter, a receiver, a signal processor, a data processor, a terminal, etc.

### The Functions of Each Part are Briefly Summarized as Follows:

(1) Antenna, for radiating high-power signals and receiving echo signals from the scattering of targets;
(2) Waveform generator, also known as frequency synthesizer (referred to as FS), for generating radio frequency excitation signals and simultaneously providing coherent local oscillation signals for a radar receiver;
(3) Transmitter, i.e., a high-power transmitting part, for amplifying and filtering the radio frequency excitation signals;
(4) Receiver, i.e., a low-power receiving part, for amplifying, mixing and filtering the received signals;
(5) Signal processor for processing the echo signals correspondingly, improving the signal-to-noise ratio of the echoes, simultaneously suppressing noise and interference, and detecting the target;
(6) Data processor for performing track management and tracking filter based on the detection results; and
(7) Terminal display and data transmission for displaying the original video and trace point of the echo signals, and uploading the trace point information of the target.

The disclosure further provides a computer-readable storage medium, wherein the computer-readable storage medium has a computer program stored thereon, the computer program is executed by a signal determination system to execute the steps of the signal determination method based on a quantum genetic algorithm based on any one of the above embodiments.

It should also be noted that relationship terms such as first and second, etc. are used herein only to distinguish one entity or operation from another without necessarily requiring or implying any such actual relationship or order between those entities or operations. Moreover, the terms “comprise”, “include” or any other variation thereof, are intended to cover a non-exclusive inclusion, such that a process, a method, an article, or an apparatus including a list of elements includes not only those elements, but also other elements not explicitly listed or can include elements inherent to the process, method, article, or apparatus. Without further limitation, an element defined by the statement of “including a . . . ” does not exclude the further presence of additionally identical elements in a process, a method, an article or an apparatus including said element.

Those skilled in the art can further realize that the units and algorithmic steps of the examples described in conjunction with the embodiments disclosed herein can be implemented in electronic hardware, computer software, or a combination thereof. To clearly illustrate the interchangeability of hardware and software, the components and steps of the examples have been described generally in terms of function in the above description. Whether these functions are performed in hardware or software depends on the particular application and design constraints of the technical solution. Those skilled in the art can use different methods to execute the described functions for each particular application, but such implementations should not be considered as going beyond the scope of the disclosure.

The steps of the methods or algorithms described in conjunction with the embodiments disclosed herein can be implemented directly with hardware, a software module executed by a processor, or a combination thereof. A software module can be placed in random access memory (RAM), memory, read-only memory (ROM), electrically programmable ROM, electrically erasable programmable ROM, a register, a hard disk, a removable diskette, a CD-ROM, or any other form of storage medium known in the art.

What is claimed is:

1. A signal determination method based on a quantum genetic algorithm, applied to a signal determination system, wherein the signal determination system is connected to a radar system, the determination method comprising:
determining the number of phase-coded radar signals transmitted by the radar system and a length of phase-coded radar signals transmitted by the radar system;
constructing P*G*C qubits based on the determined algorithm operation parameters, the algorithm operation parameters comprising population number P, chromosome number C, gene number G, rotation angle θ, mutation probability and termination parameters, the population number P is the number of phase-coded radar signals transmitted by the radar system, the gene number G is the length of phase-coded radar signals transmitted by the radar system, and P, C, G and θ are all greater than 0;
determining gene sequences of P*C first chromosomes based on all the qubits, each population comprising C first chromosomes, and each of the first chromosomes comprising G qubits;
judging whether there exists a first chromosome that satisfies a preset termination condition in all the first chromosomes; wherein, the termination condition is set based on the termination parameters;
if yes, taking the first chromosome that satisfies a preset termination condition as a phase-coded radar signal transmitted by the radar system;
if no, updating all the first chromosomes based on the mutation probability, a preset crossover strategy, a quantum catastrophe strategy and the rotation angle θ to obtain P*C second chromosomes, each of the populations comprising C second chromosomes, and each of the second chromosomes comprising G qubits; and
replacing all the first chromosomes in each of the populations with all the second chromosomes, and proceeding to the step of judging whether there exists a first chromosome that satisfies a preset termination condition in all the first chromosomes.

2. The signal determination method based on a quantum genetic algorithm of claim 1, wherein, when the phase-coded radar signal is a binary-phase-coded radar signal, the step of constructing P*G*C qubits based on the determined algorithm operation parameters comprises:
constructing P*G*C qubits in a uniform superposition state based on the determined algorithm operation parameters;
the step of determining gene sequences of P*C first chromosomes based on all the qubits comprising:
determining a corresponding classical bit state after all the qubits are collapsed, the value of the classical bit state is 0 or 1; and
determining P*C first chromosomes based on all the classical bit states, the first chromosome is a binary sequence comprising G classical bit states.

3. The signal determination method based on a quantum genetic algorithm of claim 2, after determining C first chromosomes based on all the classical bit states, further comprising:
restoring all the collapsed qubits to a pre-collapse state based on all the classical bit states.

4. The signal determination method based on a quantum genetic algorithm of claim 2, wherein, the step of updating all the first chromosomes based on the mutation probability, a preset crossover strategy, a quantum catastrophe strategy and the rotation angle θ to obtain P*C second chromosomes comprises:
determining m chromosomes in all the first chromosomes based on the mutation probability, m is a positive integer not greater than C;
applying a preset X gate to all the unmutated chromosomes to obtain m third chromosomes, the X gate is:
$$X = [ \begin{matrix}0 & 1 \\ 1 & 0\end{matrix} ] ;$$
updating C-m first chromosomes and m third chromosomes based on a preset crossover strategy, a quantum catastrophe strategy and the rotation angle θ to obtain P*C second chromosomes.

5. The signal determination method based on a quantum genetic algorithm of claim 4, wherein the crossover strategy is a full interference crossover strategy.

6. The signal determination method based on a quantum genetic algorithm of claim 4, wherein the step of updating C-m first chromosomes and m third chromosomes based on a preset crossover strategy, a quantum catastrophe strategy and the rotation angle θ to obtain P*C second chromosomes comprises:
combining C-m first chromosomes and m third chromosomes as new first chromosomes; and
determining fitness values of all the new first chromosomes based on all the new first chromosomes and a preset fitness relational expression;
updating all the new first chromosomes based on the rotation angle θ, a target chromosome with the largest fitness value in the last iteration, and a preset quantum rotating gate expression to obtain P*C fourth chromosomes, the quantum rotating gate expression is:
$$U ( {θ}_{i} ) = [ \begin{matrix}cos ( {θ}_{i} ) & - sin ( {θ}_{i} ) \\ sin ( {θ}_{i} ) & cos ( {θ}_{i} )\end{matrix} ] ;$$
wherein, θᵢ=0 when the i^{th} classical bit state of any chromosome in the new first chromosomes is the same as the i^{th} classical bit state of the target chromosome with the largest fitness value in the last iteration; determining a rotation direction based on the quadrant where any chromosome in the new first chromosomes is located, and adjusting θᵢ based on the rotation direction and a set adjustment angle when the i^{th} classical bit state of any chromosome in the new first chromosomes is different from the i^{th} classical bit state of the target chromosome with the largest fitness value in the last iteration;
determining a target chromosome with the largest fitness value in the next iteration based on the chromosome with the largest fitness value in all the fourth chromosomes and the target chromosome with the largest fitness value in the last iteration;
judging whether the number of consecutive set times of the target chromosome with the largest fitness value is unchanged; wherein the number of set times is determined based on the total iteration times and a set proportion;
initializing the rest chromosomes in all the fourth chromosomes except the chromosome with the largest fitness value based on a set replacement proportion, so as to obtain a second chromosome when the number of consecutive set times of the target chromosome with the largest fitness value is unchanged; and
taking the fourth chromosome as the second chromosome when the number of consecutive set times of the target chromosome with the largest fitness value is changed.

7. The signal determination method based on a quantum genetic algorithm of claim 1, wherein when the termination parameters comprise a fitness threshold, the step of determining whether there exists a first chromosome that satisfies a preset termination condition in all the first chromosomes comprises:
determining fitness values of all the first chromosomes based on all the first chromosomes and a preset fitness relational expression;
judging whether there exists a first chromosome with the fitness value being not less than the fitness threshold in all the first chromosomes;
if yes, judging that there exists a first chromosome that satisfies a preset termination condition in all the first chromosomes; and
if no, judging that there does not exist a first chromosome that satisfies a preset termination condition in all the first chromosomes.

8. A quantum computing device based on a quantum genetic algorithm, applied to a signal determination system for phase-coded radar signals, wherein the signal determination system is connected to a radar system, the quantum computing device comprising:
a quantum building module for constructing P*G*C qubits based on the determined algorithm operation parameters, the algorithm operation parameters comprising population number P, chromosome number C, gene number G, rotation angle θ, mutation probability and termination parameters, the population number P is the number of phase-coded radar signals transmitted by the radar system, the gene number G is the length of the phase-coded radar signals transmitted by the radar system, and P, C, G and θ are all greater than 0;
a first chromosome determination module for determining gene sequences of P*C first chromosomes based on all the qubits, each population comprising C first chromosomes, and each of the first chromosomes comprising G qubits;
a termination condition judging module for judging whether there exists a first chromosome that satisfies a preset termination condition in all the first chromosomes;
wherein, the termination condition is set based on the termination parameters;
a termination module, if yes, for taking the first chromosome that satisfies a preset termination condition as the phase-coded radar signals transmitted by the radar system;
a second chromosome determination module, if no, for updating all the first chromosomes based on the mutation probability, a preset crossover strategy, a quantum catastrophe strategy and the rotation angle θ to obtain P*C second chromosomes, each of the populations comprising C second chromosomes, and each of the second chromosomes comprising G qubits; and
a loop module for replacing all the first chromosomes in each of the populations with all the second chromosomes, and proceeding to the step of judging whether there exists a first chromosome that satisfies a preset termination condition in all the first chromosomes.

9. A signal determination system based on a quantum genetic algorithm, comprising:
a quantum computing device for executing the steps of a signal determination method based on a quantum genetic algorithm of claim 1; and
a radar system for transmitting phase-coded radar signals determined based on the quantum computing device and receiving an echo corresponding to the phase-coded radar signals.
